(19) United States
(12) Patent Application Publication
(10) Pub. No.: US 2010/0124953 A1
(43) Pub. Date: May 20, 2010

(54) Electronic device with a sliding and rotating cover

(76) Inventors: Yi-Che Yang, Jhonghe City (TW); Ching-Hong Huang, Keelung City (TW); Chao-Yu Lee, Sijhih City (TW); Way-Han Dai, Linkou Township (TW); Hsu-Chi Kao, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/292,354

(22) Filed: Nov. 18, 2008

(51) Int. Cl. H04M 1/00

(52) U.S. Cl. 455/575.3

(57) ABSTRACT

An electronic device with a sliding and rotating cover is provided. The electronic device comprises a fixed member, a rotating member pivoted with the fixed member, an elastic member disposed between the rotating member and the fixed member, a sliding member installed at the rotating member and may slide relatively to the rotating member, a casing connected with the fixed member, and a cover connected with the sliding member. Via this arrangement, the cover slides with the sliding member. The sliding member can rotate with the rotating member by the elastic member. Thus, the cover can rotate relatively to the casing.

### BACKGROUND OF THE INVENTION

1. Field of the Invention

The present invention relates to an electronic device; in particular, to an electronic device having a casing and a cover connected to the casing, with the cover being capable of sliding and rotating relatively with the casing.

2. Description of Related Art

In a conventional electronic device with a cover, such as mobile phone, the ways to open the cover can be generally categorized as cover-raising type and cover-sliding type, in which the cover of a cover-sliding mobile phone should be connected with the body and slides relatively to the body, meaning that, upon opening or closing the cover, it is required to push the cover. In a currently available cover-sliding mobile phone, after sliding out the cover, the screen of the cover is mainly parallel to the body; but such an arrangement actually does not meet ergonomic requirements, so that the user tend to feel uncomfortable when viewing the screen, causing inconvenience in use.

Consequently, because of the above technical defects, the inventor keeps on carving unflaggingly through wholehearted experience and research to develop the present invention, which can effectively improve the defects described above.

### SUMMARY OF THE INVENTION

The essential objective of the present invention is to provide an electronic device with a sliding and rotating cover, in which the cover may rotate and change its angle as it slides, so that the user can conveniently view the screen installed thereon.

To achieve the aforementioned objective, the present invention provides an electronic device with a sliding and rotating cover, comprising: a fixed member; a rotating member pivoted with the fixed member; an elastic member disposed between the rotating member and the fixed member; a sliding member installed at the rotating member and slides relatively to the rotating member; a casing connected with the fixed member, the casing having a front end portion and a rear end portion opposite to the front end portion; and a cover connected with the sliding member so as to allow the cover to slide conjunctively with the sliding member, wherein the cover has a front end portion and a rear end portion respectively corresponding to the front end portion and the rear end portion of the casing; thereby the elastic member can drive the rotating member to conjunctively move the sliding member and rotate it relatively to the fixed member, thus allowing the cover to rotate relatively to the casing.

The present invention provides the following beneficial effects: through the special structural design composed of the sliding member, rotating member, and fixed member, the present invention allows the cover connected to the sliding member to rotate relatively with the casing connected to the fixed member, thereby enabling the user to conveniently view the screen installed on the cover.

In order to facilitate further understanding of the technologies, methods, and contents taken by the present invention to achieve the prescribed objectives, references are herein made to the detailed descriptions and appended drawings of the present invention, and it is believed that the purposes, characteristics, and features of the present invention can be thereby thoroughly and concretely appreciated; however, the appended drawings are simply referential and illustrative, rather than being applied to limit the scope of the present invention.

### BRIEF DESCRIPTION OF THE DRAWINGS

FIG. 1 shows a stereo dissembled diagram of a first embodiment according to the present invention.

FIG. 2 shows a stereo dissembled diagram at another angle of the first embodiment according to the present invention.

FIG. 3 shows a stereo assembled diagram of the first embodiment according to the present invention.

FIG. 4 shows a motion diagram (1) of the first embodiment according to the present invention.

FIG. 5 shows a motion diagram (2) of the first embodiment according to the present invention.

FIG. 6 shows a motion diagram (3) of the first embodiment according to the present invention.

FIG. 7 shows a state diagram of the rotating member, sliding member, and second elastic member when the first embodiment according to the present invention is in a retracted state.

FIG. 8 shows a state diagram of the rotating member, sliding member, and second elastic member when the first embodiment according to the present invention is in a sliding state.

FIG. 9 shows a stereo dissembled diagram of the rotating member, sliding member, and first elastic member of the first embodiment according to the present invention.

FIG. 10 shows a side view diagram of the rotating member, sliding member, and first elastic member of the first embodiment according to the present invention.

FIG. 11 shows a stereo dissembled diagram of another rotating member, sliding member, and first elastic member according to the present invention.

FIG. 12 shows a stereo dissembled diagram at another angle of another rotating member, sliding member, and first elastic member according to the present invention.

FIG. 12A shows an enlarged diagram of portion A in FIG. 12.

FIG. 12B shows an enlarged diagram of portion B in FIG. 12.

FIG. 13 shows a diagram of an axle according to the present invention.

FIG. 14 shows a side view diagram of another rotating member, sliding member, and first elastic member according to the present invention.

FIG. 15 shows a motion diagram (1) of the second embodiment according to the present invention.

FIG. 16 shows a motion diagram (2) of the second embodiment according to the present invention.

FIG. 17 shows a motion diagram (3) of the second embodiment according to the present invention.

### DETAILED DESCRIPTION OF PREFERRED EMBODIMENTS

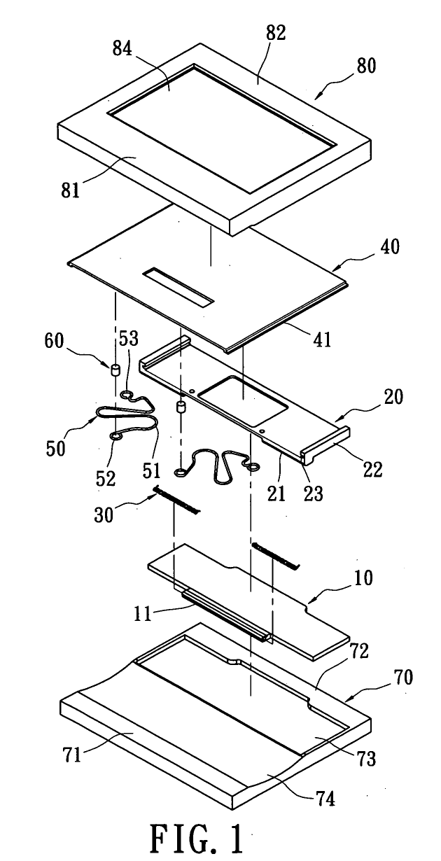

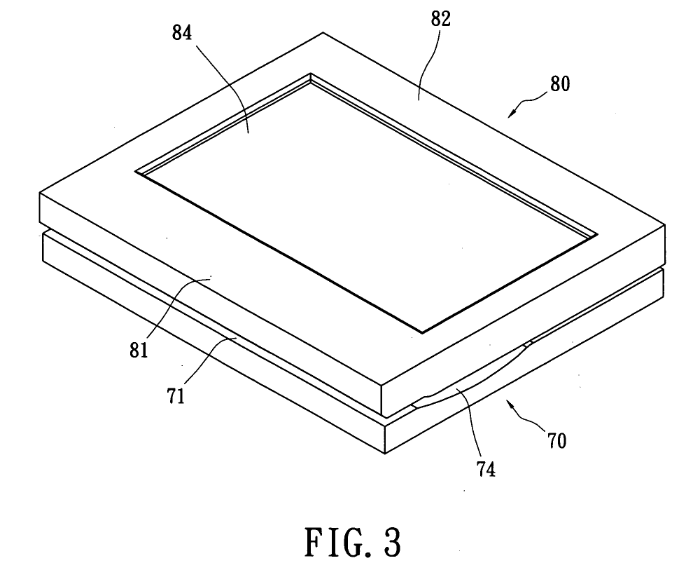

Referring now to FIGS. 1 to 3, the first embodiment according to the present invention is shown therein and provides an electronic device with a sliding and rotating cover, in which the electronic device may be a mobile phone, Personal Digital Assistant (PDA) etc., herein a mobile phone is taken as an example, but the present invention by no means limited thereto. The electronic device comprises: a fixed member 10, a rotating member 20, at least one first elastic member 30, a sliding member 40, a casing 70; and a cover 80.

On the front end of the fixed member 10 there installs at least one first fastening portion 11, and on the front end of the sliding member 20 there install two second fastening portions 21 corresponding to the first fastening portion 11, wherein the two second fastening portions 21 being individually connected to two sides of the first fastening portion 11. Additionally, the sliding member 20 has two sidewalls 22, and on these two sidewalls 22 there respectively installs a guiding groove 23.

The first elastic member 30 is installed between the rotating member 20 and fixed member 10; in the present embodiment, the first elastic member 30 is a torque spring, which is not limited in terms of number, but merely exemplified as two torque springs in the figures. The first elastic member 30 provides the rotating member 20 with a torque, force rotating upward, so that the rotating member 20 can rotate relatively to the fixed member 10.

On two sides of the sliding member 40 there respectively installs a guiding track 41, wherein the two guiding tracks 41 being installed at the two guiding grooves 23 of the rotating member 20 so that the two guiding tracks 41 may slide along the two guiding grooves 23, thereby the sliding member 41 can slide relatively to the rotating member 20.

The casing 70 has a front end portion 71 and a rear end portion 72 opposite to the front end portion 71. The casing 70 is configured with an installation portion 73 corresponding to the fixed member 10, which in the present embodiment, is exemplified as a recess space, but not limited thereto. The fixed member 10 is accommodated in the recess space and fixed to the casing 70, while there on the surface of one side of the casing 70 near the cover 80 installs a recess area 74.

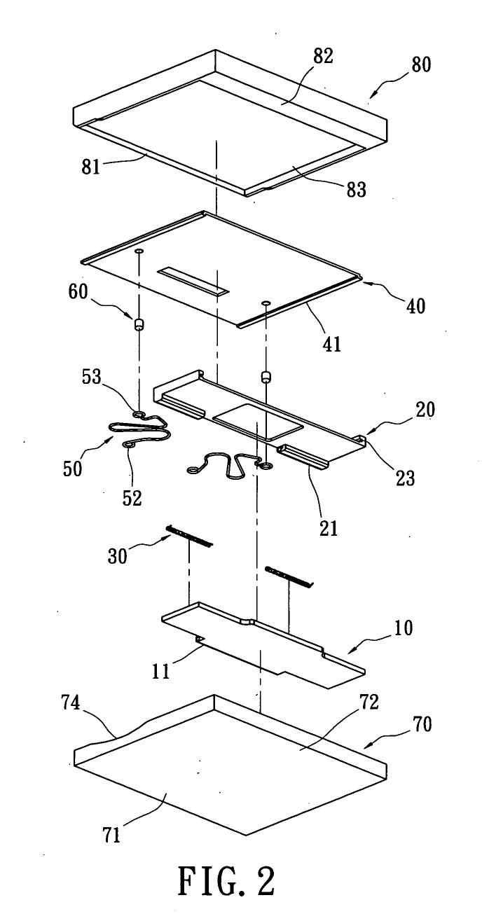

The cover 80 also has a front end portion 81 and a rear end portion 82, in which the front end portion 81 and the rear end portion 82 respectively corresponds to the front end portion 71 and the rear end portion 72 of the casing 70. On the surface of one side of the cover 80 near to the casing 70 installs an installation portion 83 (refer to FIG. 2), which, in the present embodiment, is exemplified as a recess space, but not limited thereto; the sliding member 40 is accommodated in the recess space and fixed to the cover 80, and the cover 80 may slide with the sliding member 40 relatively to the casing 70. On the surface of cover 80 there installs a screen 84; through the above-described configuration, the electronic device with a sliding and rotating cover is formed.

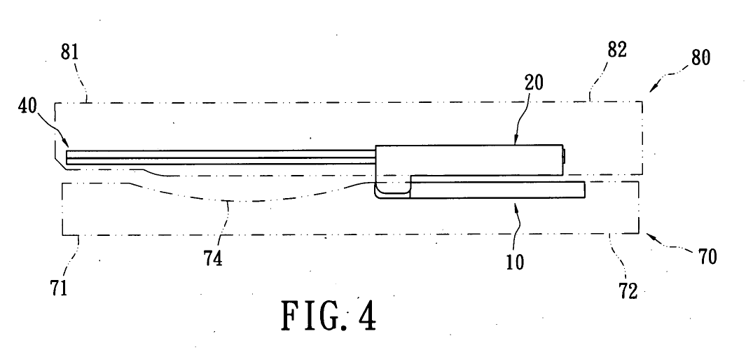

Refer now to FIG. 4, wherein, as the electronic device (i.e. the mobile phone) is in a retracted state, the cover 80 is folded on the casing 70, and the front end portion 81 and the rear end portion 82 of the cover 80 are respectively located in correspondence over the front end portion 71 and the rear end portion 72 of the casing 70. When the user intends to use the mobile phone, it is possible to push the cover 80, thus making the sliding member 40 driven by the cover 80 to slide toward the rear end portion 72 of the casing 70.

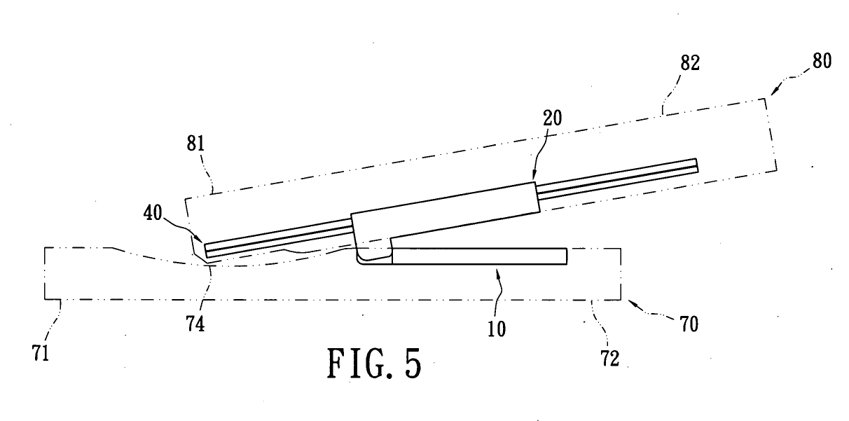

Refer now to FIG. 5, when the front end portion 81 of the cover 80 slides over the recess area 74 of the casing 70, the rotating member 20 driven by the first elastic member 30 conjunctively drives the sliding member 40 to rotate relatively to the fixed member 10, so that the front end portion 81 of the cover 80 moves downward into the recess area 74; while the rear end portion 82 thereof rises up, thus the cover 80 can rotate upward freely relatively to the casing 70.

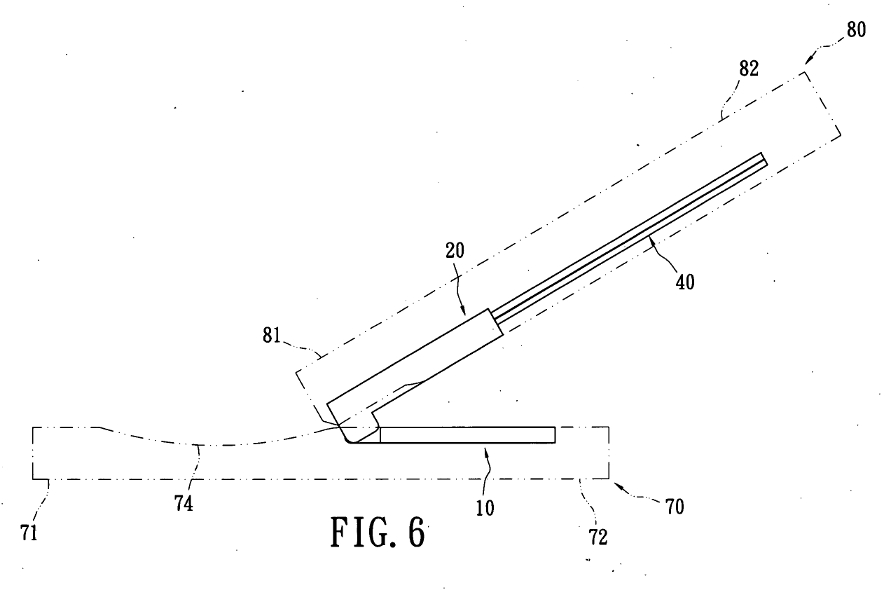

Meanwhile, the sliding member 40 keeps sliding relatively to the rotating member 20; as the cover 80 continues to slide slantwise upward to a position, the mobile phone is in a slide-up state as shown in FIG. 6, which allows the screen 84 to face up at a certain angle relative with the casing 70, so that the user can conveniently view the contents displayed on the screen 84.

Referring again to FIGS. 1 and 2, the electronic device shown therein may further comprise at least one second elastic member 50, in which the second elastic member 50 may be a spring, the spring being formed by bending a spring line, and on the line segment of the spring line there form plural bended portions 51. The second elastic member 50 has a first end 52 and a second end 53, in which the first end 52 and the second end 53 of the second elastic member 50 can be matched with two rivets 60, thereby pivoting the first end 52 with the rotating member 20, and also pivoting the second end 53 with the sliding member 40 in order to allow the second end 53 to move conjunctively with the sliding member 40. The second elastic member 50 is installed slantwise between the rotating member 20 and the sliding member 40. The number of the second elastic member 50 is not limited; two second elastic members 50 are shown in Figures as an example.

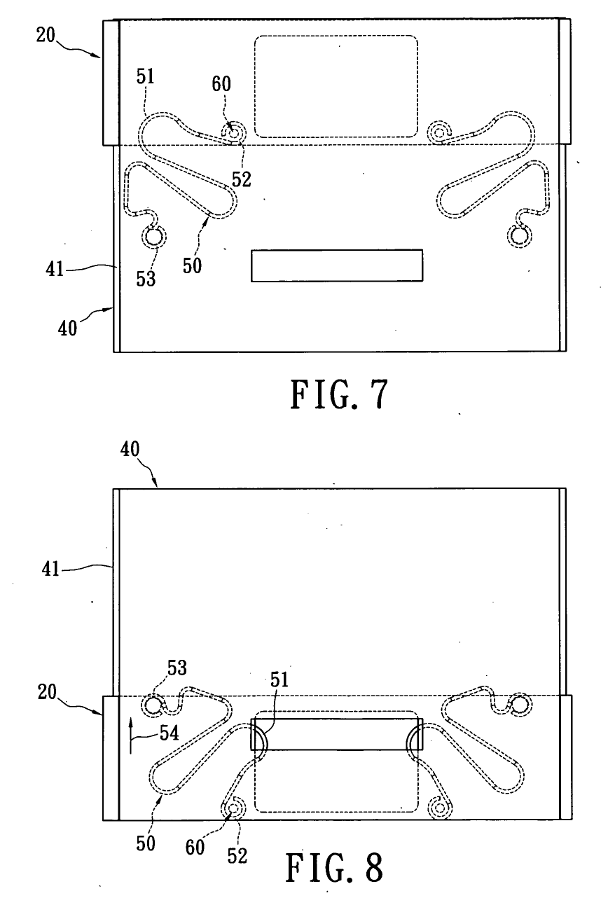

Refer once again to FIG. 4. At this moment, the electronic device has not been started yet, thus the cover 80 is folded over the casing 70 and the positions of the two second elastic members 50 at this moment are shown in FIG. 7. To open the electronic device, the user may apply a force to push the cover 80, and such a force needs to be greater than the resistance of the second elastic member 50 to make the cover 80 slide, conjunctively driving the sliding member 40 to move toward the rear end portion 72 of the casing 70, meanwhile allowing the bended portion 51 of the second elastic member 50 to be compressed to store kinetic energy.

When the pivoting point between the sliding member 40 and the second end 53 of the second elastic member 50 passes over the pivoting point between the rotating member 20 and the first end 52 of the second elastic member 50, the user may no longer need to apply force to push the cover 80, but may make the sliding member 40 continue to slide through via the force 54 applied on the sliding member 40 which is generated by the expansion of the second elastic member 50 (as shown in FIG. 8), so as to allow the cover 80 to automatically slide to a fixed position (as shown in FIG. 6).

Furthermore, as the sliding member 40 slides to the fixed position, the second elastic member 50 can provide the sliding member 40 with a supportive force which causes the sliding member 40 to be kept at the fixed position with no further motion. Thereby, the cover 80 can automatically slide and be maintained at an up-rise position, facilitating the user to conveniently watch the screen 84 installed on the cover 80.

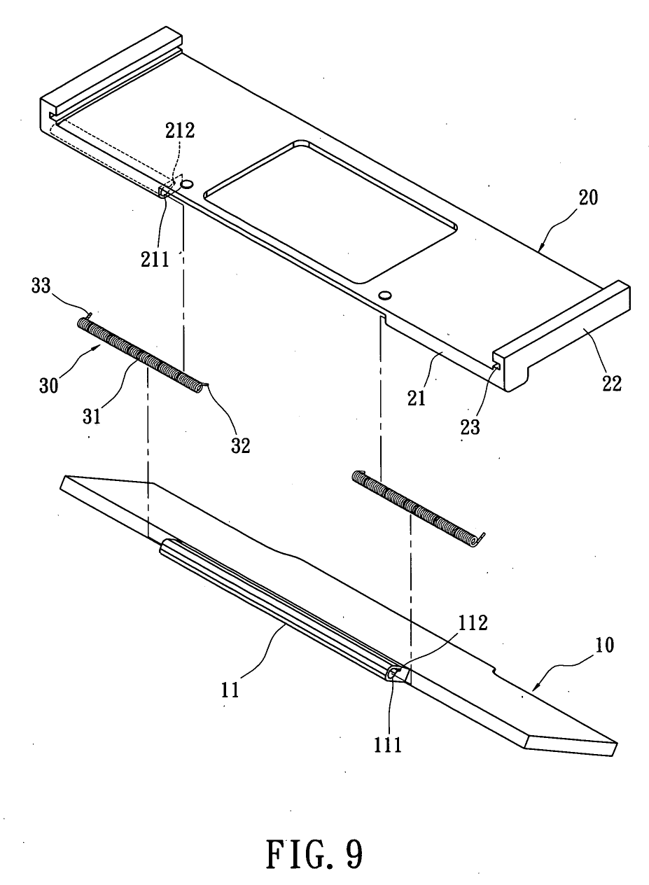

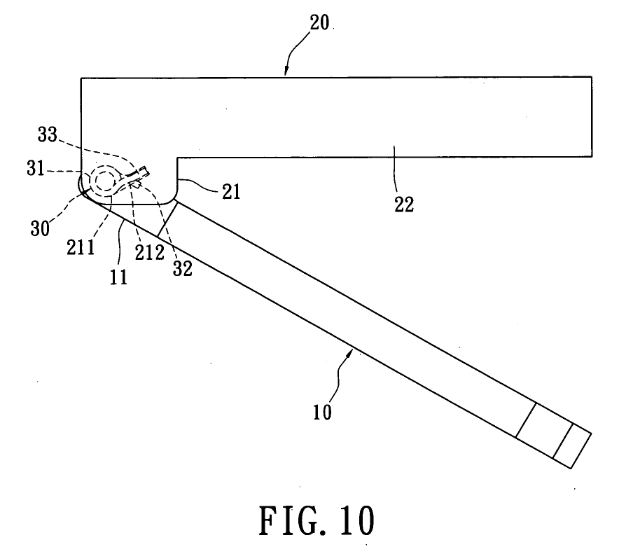

Also, the connection relationship among the aforementioned fixed member 10, rotating member 20, and first elastic member 30 will now be further explained with reference to FIGS. 9 and 10.

The above-mentioned first elastic member 30 has a spring coil 31, in which a first end 32 and a second end 33 respectively extends slantwise from the two ends of the spring coil 31, and the slant angles of the first end 32 and the second end 33 are different. On both sides of the first fastening portion 11 of the front end in the fixed member 10 respectively installs a first fastening hole 111 and a first buckling hole 112 connected to the first fastening hole 111. On the two second fastening portions 21 of the rotating member 20 there respectively installs a second fastening hole 211 corresponding to the first fastening hole 111, and a second buckling hole 212 connected to the second fastening hole 211.

The second fastening hole 211 of the rotating member 20 and the corresponding first fastening hole 111 of the fixed member 10 individually receives a portion of the spring coil 31 in the first elastic member 30, in which the first end 32 of the first elastic member 30 is plugged in the first buckling hole 112, and the second end 33 thereof is plugged in the second buckling hole 212. Hence, the second fasten portion 21 of the rotating member 20 may be connected in rotation with the first fastening portion 11 of the fixed member 10 through the first elastic member 30, and the rotating member 20 can be driven by the first elastic member 30 so as to rotate relatively with the fixed member 10.

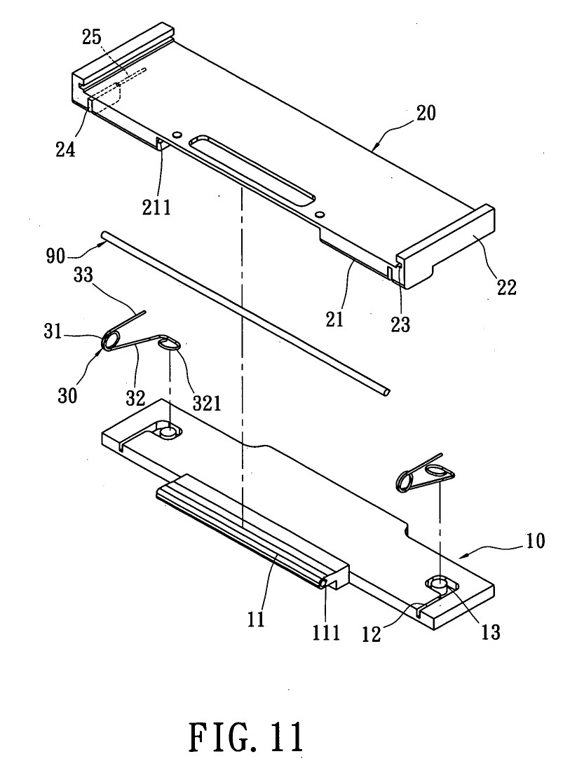

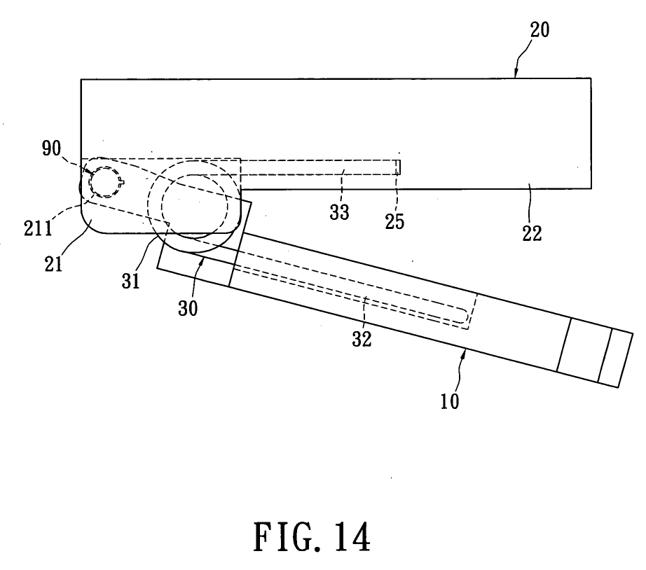

Referring to FIGS. 11 to 14, another type of the fixed member 10, rotating member 20, and first elastic member 30 is disclosed, wherein the first elastic member 30 also has a spring coil 31 as well as the first end 32 and second end 33 extending from the both ends of the spring coil 31; the terminal portion of the first end 32 is additionally bended to form a hook 321, and the slant angles of the second end 33 and the first end 32 are different.

On two sides of the top side of the fixed member 10 there respectively installs an installation groove 12, while on the inner side of each installation groove 12 there installs a bumpy post 13; the first end 32 of each first elastic member 30 is accommodated in the installation groove 12, and the hook 321 buckles to the post 13, thereby the fixed member 10 provides the first elastic member 30 with a supportive force. On two lower sides of the rotating member 20 there respectively installs an accommodation groove 24 and a plugging hole. 25 which is connected to the accommodation groove 24, in which the spring coil 31 of the first elastic member 30 is received in the accommodation groove 24, and the second end 33 is inserted into the plugging hole 25.

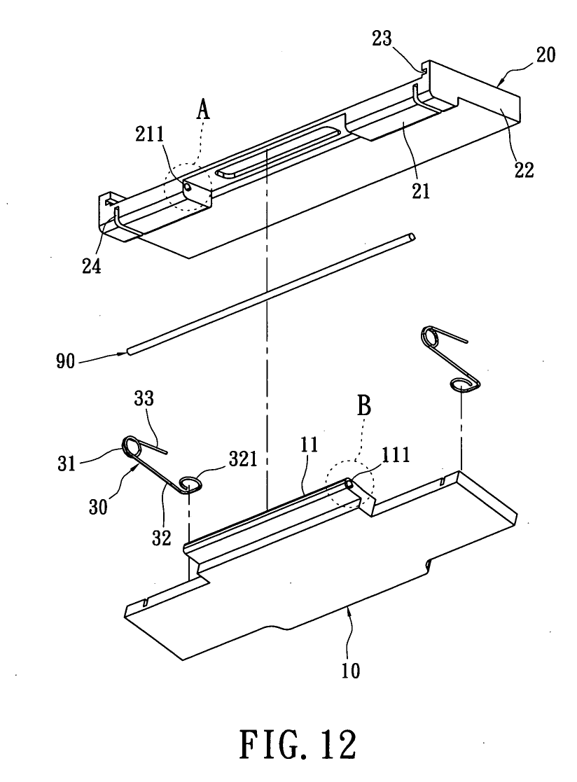

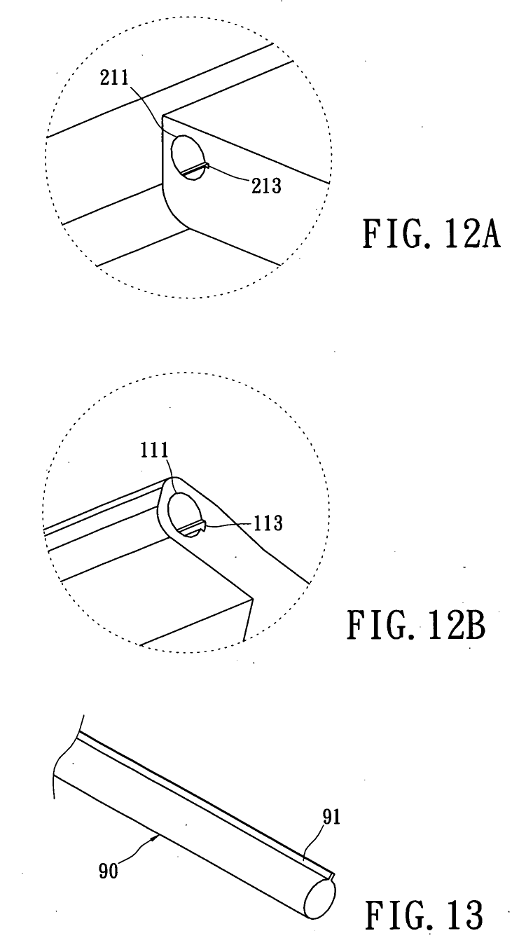

Additionally, the electronic device further comprises an axle 90 which is largely in a form of cylinder, and a stopping bar 91 extends from one side of the axle 90 along the axial direction thereof (as shown in FIG. 13). On two second fastening portions 21 of the rotating member 20 there respectively installs a second fastening hole 211 and a plugging groove 213 connected to the second fastening hole 211 (as shown in FIG. 12A), in which the width of the plugging groove 213 is exactly the same as the stopping bar 91. The two ends of the axle 90 are respectively inserted into the corresponding second fastening holes 211, and the two ends of the stopping bar 91 are plugged into the two plugging grooves 213, allowing the rotating member 20 to drive the axle 90 to rotate. The first fastening portion 11 of the fixed member 10 is installed and penetrates a first fastening hole 111 and a positioning groove 113, wherein the position groove 113 is connected to the first fastening hole 111 (as shown in FIG. 12B). In the present embodiment, the cross-section of the positioning groove 113 is fan-shaped, and the cross-section area thereof is greater than the plugging groove 213. The middle portion of the axle 90 is installed and penetrates through the first fastening hole 111, and the middle portion of stopping bar 91 is placed in the positioning groove 113.

Therefore, the second fastening portion 21 of the rotating member 20 can be connected in rotation to the first fastening portion 11 of the fixed member 10 through the axle 90, and the first elastic member 30 can be used to drive the rotating member 20 to rotate relatively with the fixed member 10. At the same time, it is possible to use the two opposite inner walls of the positioning groove 113 to block the rotation of the stopping bar 91 of the axle 90, thereby achieving the function for limiting the rotation angle of the cover 80.

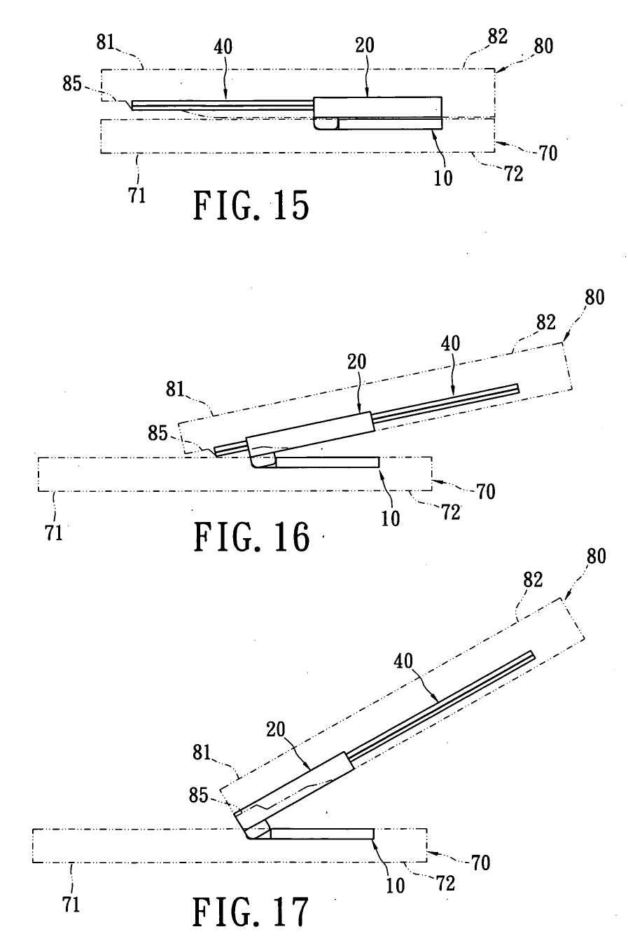

Referring now to FIGS. 15 to 17, the second embodiment according to the present invention is shown therein, which is different from the first embodiment in that:

On the surface of one side of the cover 80 near to the casing 70 there installs a recess area 85, such that when the front end portion 81 of the cover 80 slides to the middle section of the casing 70, the cover 80 can be free from the restriction of the casing 70 by the recess area 85 and rotates relatively to the casing 70. Similarly, the cover 80 of the electronic device can start to slide in a state of being folded over the casing 70 (as shown in FIG. 15), rotating upward relatively to the casing 70 through the driving of the first elastic member 30 (as shown in FIG. 16), finally moving upward slantwise to a positioning state (as shown in FIG. 17), thereby achieving the function of rising up the screen 84 at an angle relatively to the casing 70. As such, the electronic device with a sliding and rotating cover according to the present invention provides the following features and functions:

1. the sliding member 40 of the present invention can slide relatively to the rotating member 20, and the rotating member 20 can rotate relatively to the fixed member 10, such that the cover 80 connected to the sliding member 40 can rotate relatively to the casing 70 that is connected to the fixed member 10, allowing the screen 84 installed on the cover 80 to rise up and positioned at a preferred angle-of-view relative with the user's face, enabling more comfortable and convenient viewing of the screen 84 by the user;

2. after sliding for a certain distance, the sliding member 40 of the present invention can be otherwise driven by a force from the second elastic member 50 to automatically push the sliding member 40 to a fixed position;

3. after the sliding member 40 of the present invention being pushed to slide to the fixed position, it is possible to use a supportive force provided by the second elastic member 50 to allow the sliding member 40 of the present invention to be continuously fixed at the required position.

The aforementioned descriptions illustrate simply the preferred embodiments of the present invention, rather than being used to limit the scope of the present invention thereto. It is noted that all effectively equivalent changes and modifications made based on the present disclosure and appended drawings thereof are reasonably deemed to be encompassed within the scope of the present invention.

What is claimed is:

1. An electronic device with a sliding and rotating cover, comprising:
a fixed member;
a rotating member, pivoted with the fixed member;
an elastic member, disposed between the rotating member and the fixed member;
a sliding member, installed at the rotating member and slides relatively to the rotating member;
a casing, connected with the fixed member, the casing having a front end portion and a rear end portion opposite to the front end portion; and
a cover, connected with the sliding member so as to allow the cover to slide conjunctively with the sliding member, wherein the cover has a front end portion and a rear end portion respectively corresponding to the front end portion and the rear end portion of the casing;
thereby the elastic member can drive the rotating member to conjunctively move the sliding member and rotate it relatively to the fixed member, thus allowing the cover to rotate relatively to the casing.

2. The electronic device with a sliding and rotating cover according to claim 1, further comprising another elastic member, wherein the another elastic member has a first end and a second end, the first end pivoted with the rotating member, the second end pivoted with the sliding member and conjunctively moving with the sliding member, and in which, after the pivoting point between the sliding member and the second end of the another elastic member passing through the pivoting point between the rotating member and the first end of the another elastic member, the another elastic member expands and applies a force to push the sliding member.

3. The electronic device with a sliding and rotating cover according to claim 2, wherein the another elastic member is a spring, the spring is formed by bending a spring line, and there on the line segments of the spring line forming multiple bended portions distributed in a planar state.

4. The electronic device with a sliding and rotating cover according to claim 1, wherein the rotating member has two sidewalls, the two sidewalls being respectively installed with a guiding groove, and on the two sides of the sliding member there respectively installs a guiding track, the two guiding tracks being installed inside the two guiding grooves for sliding, allowing the sliding member to be installed within the rotating member and to slide relatively to the rotating member.

5. The electronic device with a sliding and rotating cover according to claim 1, wherein the fixed member is installed with a first fastening hole and a first buckling hole connected to the first fastening hole, and the rotating member is installed with a second fastening hole corresponding to the first fastening hole and a second buckling hole connected to the second fastening hole, the elastic member having a spring coil, from two ends of the spring coil there extending slantwise a first end and a second end having a different slant angle from the first end, in which the second fastening hole on the rotating member and the first fastening hole on the fixed member respectively receives a portion of the spring coil, and the first end is inserted in the first buckling hole and the second end is inserted in the second buckling hole.

6. The electronic device with a sliding and rotating cover according to claim 1, wherein the fixed member is installed with an installation groove, there on the inner side of installation groove installing a post, the rotating member being installed with an accommodation groove and a plugging hole connected to the accommodation groove, in which the elastic member has a spring coil, from two ends of the spring coil there extending slantwise a first end and a second end having a different slant angle from the first end, the end portion of the first end being bended into a hook, the first end of the elastic member being accommodated in the installation groove and the hook being buckled to the post, the spring coil being received in the accommodation groove and the second end being inserted into the plugging hole.

7. The electronic device with a sliding and rotating cover according to claim 1, further comprising an axle, a stopping bar extending from one side of the axle along the axial direction thereof, the rotating member being installed with two second fastening hole and two plugging grooves connected to the second fastening hole, two end portions of the axle being respectively inserted into the two second fastening hole, two end portions of the stopping bar being inserted into the two plugging grooves, in which the fixed member is installed with a first fastening hole and a positioning groove connected to the first fastening hole, the cross-section of the positioning groove is fan-shaped, and the middle portion of the axle being installed and penetrates through the first fastening hole and the middle portion of the stopping bar being placed in the positioning groove.

8. The electronic device with a sliding and rotating cover according to claim 1, wherein on the surface of one side of the casing near the cover there is a recess area.

9. The electronic device with a sliding and rotating cover according to claim 1, wherein on the surface of one side of the cover near the casing there is a recess area.
